(19) United States
(12) Patent Application Publication
(10) Pub. No.: US 2008/0306767 A1
(43) Pub. Date: Dec. 11, 2008

(54) Weight Management System Using Adaptive Targets

(75) Inventors: Maarten Peter Bodlaender, Eindhoven (NL); Arvid Randal Nicolaas, Eindhoven (NL); Olivier Schneider, Eindhoven (NL); Mariana Simons-Nikolova, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 12/158,053

(22) PCT Filed: Dec. 18, 2006
(86) PCT No.: PCT/IB2006/054916

§ 371 Date: Jun. 19, 2008

(30) Foreign Application Priority Data
Dec. 22, 2005 (EP) 05112751.2

(51) Int. Cl. G06Q 50/00

(52) U.S. Cl. 705/2

(57) ABSTRACT

A method for managing the weight of a subject having an associated predefined target weight, comprises deriving a target energy balance and computing the realized energy balance (303) from collected information (301, 302). It further comprises determining a weight reduction plan (304) comprising a sequence of at least two phases, representing a corresponding sequence of successive time intervals, one phase representing a time interval having an end time associated with an end time of the target period. It involves assigning to each successive phase a distinct set of phase targets comprising at least one phase target relating to food intake of the subject, physical activity of the subject, or target body weight of the subject, such that according to a simulation model of the relation between energy intake, physical activity, and body weight, each phase fulfills the constraint that the respective assigned set of phase targets can be achieved.

### FIELD OF THE INVENTION

The invention relates to a method for managing the weight of a person having a starting weight at a starting time, and an associated predefined target weight to be realized within a predefined target period, comprising

deriving a target energy balance, relating to a target difference between energy intake and energy expenditure of the person, from the starting weight, the target weight, and the target period,

collecting information about the person relating to at least realized energy intake and realized energy expenditure, and

computing the realized energy balance from the collected information.

The invention also relates to a computer program product and to a system for managing the weight of a person.

### BACKGROUND OF THE INVENTION

Overweight and obesity are growing problems. To stop this trend, many weight management (WM) systems and services have been deployed to help individuals achieve weight control.

Nowadays, all WM programs include the basic steps of setting weight targets and tracking their progress over a period of time. Further, these programs focus on logging user's food intake and activity, in order to estimate the calorie balance.

In “Energy intake, physical activity and body weight: a simulation model”, by K. R. Westerterp, J. H. H. L. M. Donkers, E. W. H. M. Fredrix and P. Boekhoudt, British Journal of Nutrition (1995), referred to hereinafter as “Westerterp”, a simulation model is described and validated relating energy intake (EI), energy expenditure (EE), and changes in fat mass (FM) and fat-free mass (FFM). The model is applicable to predict the effect of a planned intervention to change EI and EE on FM and FFM. The other way around, it allows calculation of EI and EE to reach a planned value of FM and FFM at a given time interval. Thus the simulation model can teach subjects about real EI and EE and about consequences of changes in EI and EE for FM and FFM. All three studies used for the validation of the model included provisioning of a fixed diet over the entire observation interval.

The existing WM systems usually request a person to input his weight and height measurements. Optionally, they calculate associated parameters as body mass index (BMI=kg/m²) and ideal weight. The patent application EP1338245 discloses a presentation method for easy visualization of such parameters.

Further, the WM systems prompt the user to set a weight loss target and a desirable time to achieve it. Existing WM systems translate the target into energy equivalence of the weight loss using the estimates: 1 kg fat≅38.3 MJ=9192 kcal, 1 kg fat free≅3.5 MJ=840 kcal, and 1 kg body weight≅32 MJ=7700 kcal. To this end, the current weight management systems propose a fixed daily calorie balance in order to reach certain weight loss targets. For example, a target of 2 kg body weight reduction in 2 months will require approximately 257 kcal energy balance deficit per day. Then, the user should regulate the two components of the calorie balance, namely the daily food intake and daily activity expenditure, to achieve the target calorie balance each day.

In practice, users often do not reach the desired weight, and even if they do reach the desired weight, they often gain weight after having reached it.

### SUMMARY OF THE INVENTION

It is an object of the invention to provide a method for helping a person to reach a desired weight and for helping the person to maintain the desired weight.

This object is achieved by a method further comprising

determining a weight reduction plan comprising a sequence of at least two phases, representing a corresponding sequence of successive time intervals, one phase representing a time interval having an end time associated with an end time of the target period;

assigning to each successive phase a distinct set of phase targets comprising at least one phase target relating to food intake of the person, physical activity of the person, or target body weight of the person, such that
according to a simulation model of the relation between energy intake, physical activity, and body weight, each phase fulfills the constraint that the respective assigned set of phase targets can be achieved, taking into account the phases preceding the phase in the sequence, and
the phase representing the time interval having the end time associated with the end time of the target period is assigned at least a phase target related to the target weight; and

providing feedback to the person related to the phase targets and the collected information.

The phase targets are adapted to the phase in the weight loss process, which makes the phase targets more relevant to the situation of the person. The more relevant targets are more motivating to the person than a single fixed energy balance target that is not adapted to the current situation of the person. Advantageously, to make it easier for the person to reach the goals, the phase targets anticipate a gradual change in the behavior of the person rather than a large, sudden change.

According to an aspect of the invention, it further comprises periodically revising the weight reduction plan in dependence on the collected information. This allows keeping the targets relevant and achievable for the person. If the phase targets are not realized at the end of the corresponding time interval, it is advantageous to revise the phase targets of the successive phases. Advantageously, an extrapolation of relevant quantities appearing in the phase targets is used in revising the weight reduction plan. For example, if the realized weight reduction is substantially smaller than anticipated, it is advantageous to adapt the weight targets such that will be easier to realize the set targets. The person may be more motivated if he or she realizes a less ambitious target compared to if he or she does not realize a very ambitious target.

According to an aspect of the invention, it further comprises collecting further information about the person related to future events involving an estimated energy intake or an estimated energy expenditure differing from an average energy intake or an average energy expenditure, wherein the determining of the weight reduction plan and the assigning of the set of phase targets is performed also in dependence on the collected further information. For example, the person may indicate certain days with a high level of food consumption, such as a Christmas dinner, allowing the method to adapt the phase targets such that this extra energy intake is taken into account. Preferably, the phase targets comprise additional physical activity and/or a reduced energy intake in a period before and/or after a day with a high level of food consumption to compensate for the extra energy intake. Planning these targets before the day with a high level of food consumption is especially advantageous because a person may be more motivated to realize a more ambitious target if he or she has a special day as a ‘reward’. Likewise, the phase targets can be revised to compensate for a planned period of reduced physical activity, such as, in some cases, a vacation period.

According to an aspect of the invention, at least one assigned set of phase targets contains a phase target related to maintaining the target weight. For example, after reaching the desired weight, it is important to adjust the targets such that the person remains motivated to follow a diet and/or to engage in physical activity. If the targets are not adjusted, the person may become unmotivated because he or she already has achieved the desired weight and there seems to be no need to realize the same ambitious level of energy deficit. Therefore it is advantageous to set a more relevant goal to avoid the person to loose interest and gain weight again.

According to an aspect of the invention, the sequence of phases comprises at least one phase associated with a negative difference between energy intake and energy expenditure. This is necessary to achieve a significant weight reduction.

According to an aspect of the invention, at least one assigned set of phase targets contains a phase target related to a decreased food intake. Decreasing the food intake is an important step in achieving a negative energy balance.

According to an aspect of the invention, at least one assigned set of phase targets contains both a phase target related to a decreased food intake and a phase target related to an increased energy expenditure. This combination is even more effective for achieving a negative energy balance.

According to an aspect of the invention, the sequence of phases comprises at least one phase with a near-zero energy balance. This phase is related to a weight maintenance. Advantageously after having realized the desired weight loss, a target associated with near-zero energy balance is set.

According to an aspect of the invention, at least one assigned set of phase targets are expected to result in weight loss according to the simulation model and at least one assigned set of phase targets are expected to result in constant weight according to the simulation model. This is an embodiment of the combination of weight loss followed by weight maintenance.

According to an aspect of the invention, the providing feedback comprises communicating a target relating to improving the condition of the person before the target weight has been realized. This helps to keep the person motivated to work on his condition and improve his general health even when the target weight has almost been realized.

Another aspect of the invention comprises a computer program product comprising instructions for making a processor perform the method as set forth.

According to another aspect of the invention, a system for managing the weight of a person further comprises

means for determining a weight reduction plan comprising a sequence of at least two phases, representing a corresponding sequence of successive time intervals, one phase representing a time interval having an end time associated with an end time of the target period;

means for assigning to each phase a set of phase targets comprising at least one phase target relating to food intake of the person, physical activity of the person, or target body weight of the person, such that
according to a simulation model of the relation between energy intake, physical activity, and body weight, each phase fulfills the constraint that the respective assigned set of phase targets can be achieved, taking into account the phases preceding the phase in the sequence, and
the phase representing the time interval having the end time associated with the end time of the target period is assigned at least a phase target related to the target weight; and

means for providing feedback to the person related to the phase targets and the collected information.

### BRIEF DESCRIPTION OF THE DRAWINGS

These and other aspects of the method of the invention will be further elucidated and described with reference to the drawing, in which:

FIG. 1 shows phases and targets in a weight reduction plan;

FIG. 2 shows different target distribution schemes;

FIG. 3 shows weight loss predictions according to the target distribution schemes shown in FIG. 2;

FIG. 4 shows an example of a static target and a dynamic target;

FIG. 5 shows an embodiment of the invention;

FIG. 6 shows another embodiment of the invention.

### DETAILED DESCRIPTION OF THE INVENTION

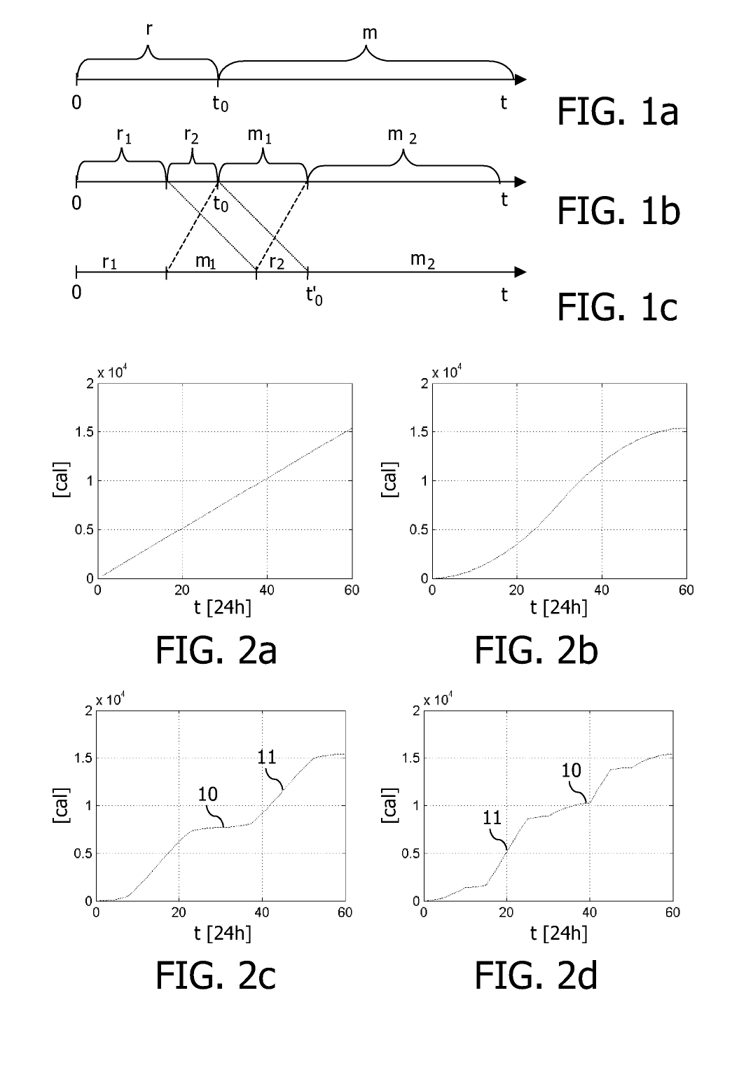

FIGS. 1a, 1b, and 1c show weight reduction plans with an increased level of complexity. In FIG. 1a, the weight reduction plan consists of two phases. In the first phase r, the goal is to lose weight, for example by realizing a negative energy balance. At the end of the first phase r, the desired target weight has been achieved, rendering the weight loss target unmotivating for the subject. The motivation of the subject is kept by setting a goal for weight maintenance during the second phase m, for example by realizing a zero energy balance.

FIG. 1b shows a refinement of FIG. 1a in that the two phases r and m have been subdivided into subphases. The weight reduction phase r has been split up into two phases r₁ and r₂, the first subphase r₁ involving a goal to decrease food intake and the second subphase r₂ involving a goal to combine a decrease of food intake with an increase of energy expenditure. The weight maintenance phase m has been split up into three subphases m₁, m₂, and m₃, the first subphase m₁, for example relating to a period in which the subject has a limited activity level, involving a goal to realize a limited food intake, the second subphase m₂, for example relating to a period in which the subject has a relatively large food intake, involving a goal to increase energy expenditure, and the third subphase m₃ involving a goal to realize a healthy personal activity level. Often during dieting, subjects show a decreased personal activity level and a decreased total energy expenditure to compensate for the decreased energy intake, becoming inactive. After weight loss, a target can be to restore the personal activity level to a healthier level. The reason for switching targets as in subphase m₃ is that weight can no longer be a target: the goal is reached, and is therefore no longer motivating for the subject. Personal activity level can still be improved, a goal can be set that is higher than the current personal activity level, thus providing a consumer new motivations and new challenges.

FIG. 1c shows how weight reduction subphases can be interchanged with for example weight maintenance subphases to adapt to the user's lifestyle. For example, during certain periods such as vacations or the Christmas period, the motivation to reduce food intake may be especially small. In FIG. 1c this is taken into account by planning a weight maintenance subphase m₁ during the period with reduced motivation, and deferring the weight reduction subphase r₂ to a later period. By adapting the weight reduction goals to the lifestyle of the subject, the situation is avoided that the subject does not realize the set goals. Because the set goals are achievable given the lifestyle of the subject, the chance that the subject will realize the goals is increased considerably. Moreover, by realizing the set goals, the motivation of the subject is increased further.

FIG. 2 shows several ways to realize a target weight loss of 2 kg, with an initial weight of 65 kg and a target weight of 63 kg in a period of 60 days. This corresponds to a total energy deficit of r=15400 kcal during the period of 60 days.

FIG. 2a shows a cumulative planned energy deficit in calories versus the number of days after having started the weight management program according to the prior art. The weight management program according to the prior art sets a fixed target energy deficit and maintains it until the target weight has been reached. This results in a constant daily target energy deficit of r_{daily}=r/60. FIG. 2b shows a cumulative planned energy deficit in calories versus the number of days after having started the adaptive weight management program according to the invention. In the method according to the invention, a sequence of phases can be defined, each phase corresponding to a successive time interval of, in this case, one or two days, and distinct intermediate targets can be assigned to each successive phase. Advantageously, the targets are designed such that the daily targets gradually become more challenging. This can be realized by associating with every day in the planning period a weight wk as follows:

$${w}_{k} = \{ \begin{matrix}\frac{k}{15} , & k = 1 , … , 15 ; \\ \frac{k - 1}{15} , & k = 16 , … , 30 ; \\ \frac{60 - k}{15} , & k = 31 , … 45 ; \\ \frac{61 - k}{15} , & k = 46 , … , 60 ;\end{matrix}$$

where k is the number of the day within the period of 60 days. The corresponding daily energy deficit target is

$${r}_{k} = \frac{{rw}_{k}}{60} , k = 1 , … 60.$$

As can be seen, this daily energy deficit target gradually increases every day until day 15. Days 1 through 14 correspond to 14 successive phases in the plan, each successive phase k having a distinct phase target with respect to daily energy deficit rₖ. Days 15 and 16 have identical target energy deficit and these days together correspond to a single phase in the plan. Similarly, days 17-29, 32-44, and 47-60 all correspond to a different phases. Days 30 and 31 together form a phase and days 45 and 46 also together form a phase. As can be seen in FIG. 2b, the result of the sequence of phases is a cumulative energy deficit

$$r = {\sum }_{k = 1}^{60} {r}_{k}$$

equivalent to that of FIG. 2a (wherein r=60r_{daily}), but with gradually increasing and decreasing target energy deficit. In the adaptive program according to the invention, it is possible to gradually increase or reduce the energy deficit, for example by a first weight reduction phase comprising a goal to reduce food intake, followed by a second weight reduction phase comprising a combined goal to maintain the reduced food intake and to increase the physical activity level. Advantageously, the phases corresponding to the first 60 days as described above are followed by one or more phases with a target energy balance around zero (not shown). Preferably, the one or more phases comprise a target relating to an increase of the physical activity level and/or other targets to increase the person's health or condition, such as for example stopping with smoking.

FIGS. 2c and 2d show other examples of a cumulative planned energy deficit in calories versus the number of days after having started the adaptive weight management program according to the invention. These examples show a variation of the subject's energy balance. In particular, some periods 10 are visible that could be labeled as weight maintenance subphases, whereas some other periods 11 are visible that could be labeled as weight reduction subphases.

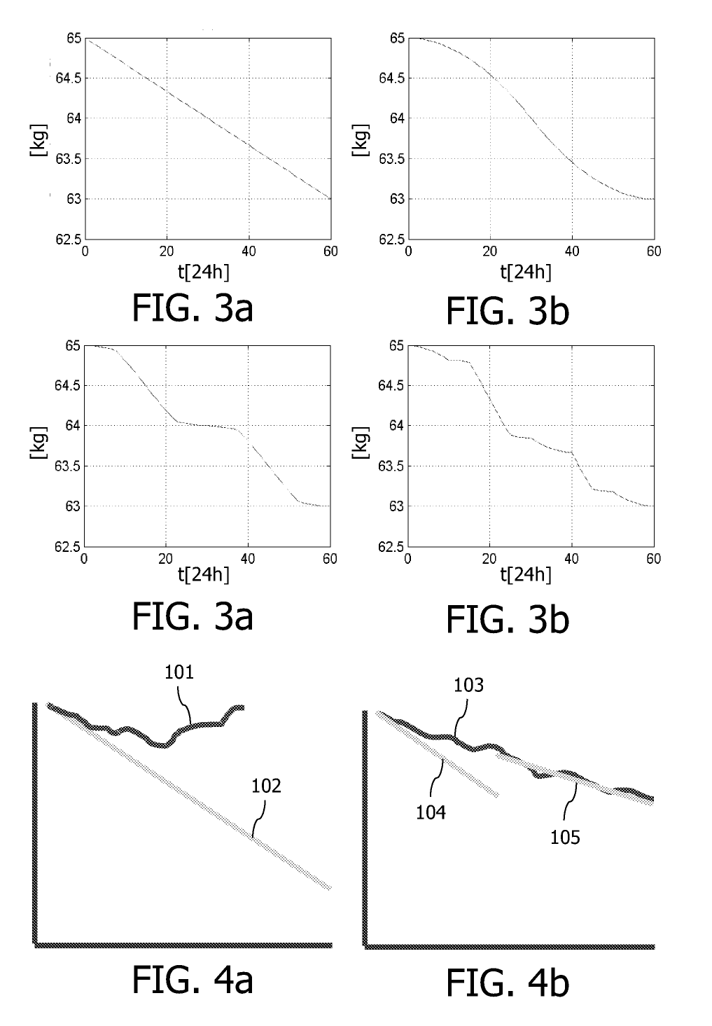

FIGS. 3a through 3d show the weight loss prediction in kg versus the number of days after having started the weight management program according to FIGS. 2a through 2d, respectively. The figures show the relation between energy deficit and weight loss prediction.

FIG. 4a shows the predicted 102 versus the realized 101 weight of the subject as a function of time in the case of a weight management system using a fixed goal. The realized weight loss is less than the predicted weight loss according to the target set by the weight management system. This possibly makes the subject less motivated to keep the diet and activity program, which results in a restoration of the original weight of the subject.

FIG. 4b shows the initial predicted 104 versus the realized 103 weight of the subject as a function of time in the case of a weight management system using an adaptive goal. After the weight management system detects that the subject loses weight at a slower rate than predicted, it can for example change the goals in such a way that they are easier to achieve, and still resulting in a predicted weight loss (see line 105). Because the changed goals are easier to achieve, the subject becomes again motivated and realizes a further weight loss, in contrast to the situation with the unmotivating fixed goal of FIG. 4a.

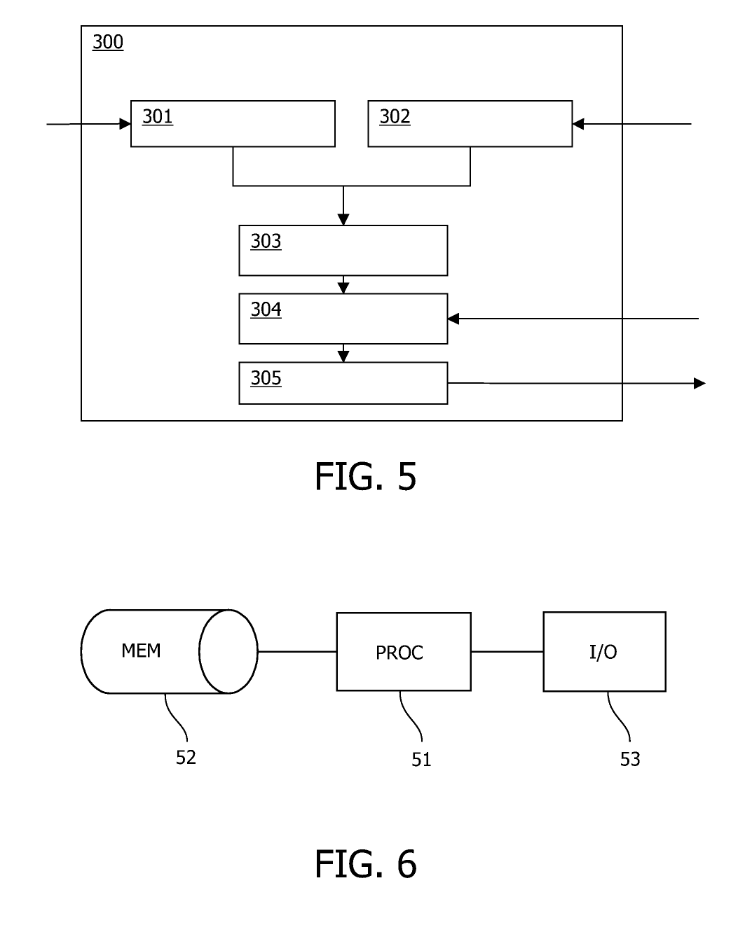

FIG. 5 shows a diagram of a weight management system 300 comprising an energy intake monitor 301 with an input for receiving information about food intake. The input is for example coupled to a user interface on which the subject enters the amounts and types of food consumed, or the input can be coupled to a system for automatic registration of food consumption. For example, the user interface can be implemented on a PDA or personal computer. The automatic registration of food consumption can be coupled to the cash desk of a shop or a restaurant.

The system 300 further comprises an energy expenditure monitor 302 with an input for receiving information about physical activity. The input is for example coupled to a tri-axial accelerometer attached to the waist of the subject or for example an ECG sensor or another system providing an output related to the energy expenditure of the subject. Alternatively, a user interface on which the subject enters for example the type and intensity of activities performed can be provided for producing the input to the energy expenditure monitor 302. The user interface can be implemented, for example, on a PDA or personal computer. Preferably the user interface for registering energy intake and the user interface for registering energy expenditure are implemented on the same PDA or personal computer. Advantageously, when the person is training in a sports center, the energy expenditure related to the sports activities of the person is measured automatically and stored in a central database and/or transmitted to the energy expenditure monitor 302.

The system 300 further comprises an energy balance component 303 that computes the energy balance of the subject based on at least the monitored energy intake and energy expenditure. The components 301, 302, and 303 can also use other information for improving the accuracy. Such information can include for example properties of the subject such as height and weight, the agenda of the subject, knowledge about activities of the subject, and more.

The system 300 further comprises a goal setting module 304. The goal setting module 304 can receive input from the subject or another person related to a goal. The goal can comprise, for example, a desired weight or a desired activity level of the subject. The goal can comprise a time at which the desired goal should be achieved. Alternatively, the goal-setting module 304 can determine the goal automatically based on a model. Preferably, the model provides goals that can improve the health of the subject, for example it is considered to be advantageous for the subject's health to make at least a predefined number of footsteps per day. Preferably, the actually realized number of footsteps per day is measured automatically using a known pedometer and provided as an input to the energy expenditure monitor 302. The realized number of footsteps can then be compared to the predefined target number of footsteps and feedback can be provided relating to the difference between realized and target number of footsteps. Also, for any given length of a subject, it is considered advantageous for the subject's health to have a weight that is within certain bounds, the bounds being dependent on the length. For example, the weight bounds can be easily calculated from a healthy person's body mass index (BMI), which should be in the range of 20 to 25 kg/m², and known length. Preferably, the goals are revised periodically in dependence on the information collected by the system 300, in the way set forth.

The system 300 further comprises a reporting and feedback module 305 that communicates selected information about the set goals and the realization of the goals to the subject. Preferably, the module also communicates selected information about the realized energy intake, energy expenditure, and energy balance to the subject. In addition, the system can indicate to the user to what extend the set goals have already been achieved and how long it will take until the goal is reached considering the current progress.

FIG. 6 shows a schematic diagram of a possible embodiment of a goal setting module. The Figure shows a central processor unit 51 arranged to execute instructions stored in the memory 52. The memory 52 contains instructions to perform the method for determining and adapting the goals according to the invention. The processor 51 is also connected to input/output (I/O) means 53 for communicating information about, for example, set goals, progress, and realized energy balance to and from the other modules and the subject. The I/O means can, for example, be coupled to a user interface, a display, a keyboard, or other modules in a weight management tool.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method for managing the weight of a person having a starting weight at a starting time, and an associated predefined target weight to be realized within a predefined target period, comprising
deriving a target energy balance, relating to a target difference between energy intake and energy expenditure of the person, from the starting weight, the target weight, and the target period;
determining a weight reduction plan comprising a sequence of at least two phases, representing a corresponding sequence of successive time intervals, one phase representing a time interval having an end time associated with an end time of the target period;
assigning to each successive phase a distinct set of phase targets comprising at least one phase target relating to food intake of the person, physical activity of the person, or target body weight of the person, such that
according to a simulation model of the relation between energy intake, physical activity, and body weight, each phase fulfills the constraint that the respective assigned set of phase targets can be achieved, taking into account the phases preceding the phase in the sequence, and
the phase representing the time interval having the end time associated with the end time of the target period is assigned at least a phase target related to the target weight;
collecting information about the person relating to at least realized energy intake and realized energy expenditure;
computing the realized energy balance from the collected information; and
providing feedback to the person related to the phase targets and the collected information.

2. The method according to claim 1, further comprising periodically revising the weight reduction plan in dependence on the collected information.

3. The method according to claim 1, further comprising collecting further information about the person related to future events involving an estimated energy intake or an estimated energy expenditure differing from an average energy intake or an average energy expenditure, wherein the determining of the weight reduction plan and the assigning of the set of phase targets is performed also in dependence on the collected further information.

4. The method according to claim 1, wherein at least one assigned set of phase targets contains a phase target related to maintaining the target weight.

5. The method according to claim 1, wherein the sequence of phases comprises at least one phase associated with a negative difference between energy intake and energy expenditure.

6. The method according to claim 5, wherein at least one assigned set of phase targets contains a phase target related to a decreased food intake.

7. The method according to claim 6, wherein at least one assigned set of phase targets contains both a phase target related to a decreased food intake and a phase target related to an increased energy expenditure.

8. The method according to claim 4, wherein the sequence of phases comprises at least one phase with a near-zero energy balance.

9. The method according to claim 1, wherein at least one assigned set of phase targets are expected to result in weight loss according to the simulation model and at least one assigned set of phase targets are expected to result in constant weight according to the simulation model.

10. The method according to claim 1, wherein the providing feedback comprises communicating a target relating to improving the condition of the person before the target weight has been realized.

11. A computer program product comprising instructions for making a processor perform the method of claim 1.

12. A system for managing the weight of a person having a starting weight at a starting time, and an associated predefined target weight to be realized within a predefined target period, comprising
means for deriving a target energy balance, relating to a target difference between energy intake and energy expenditure of the person, from the starting weight, the target weight, and the target period;
means for determining a weight reduction plan comprising a sequence of at least two phases, representing a corresponding sequence of successive time intervals, one phase representing a time interval having an end time associated with an end time of the target period;
means for assigning to each phase a set of phase targets comprising at least one phase target relating to food intake of the person, physical activity of the person, or target body weight of the person, such that
according to a simulation model of the relation between energy intake, physical activity, and body weight, each phase fulfills the constraint that the respective assigned set of phase targets can be achieved, taking into account the phases preceding the phase in the sequence, and
the phase representing the time interval having the end time associated with the end time of the target period is assigned at least a phase target related to the target weight;
means for collecting information about the person related to at least realized energy intake and realized energy expenditure;
means for computing the realized energy balance from the collected information; and
means for providing feedback to the person related to the phase targets and the collected information.
